(19) United States
(12) Patent Application Publication
(10) Pub. No.: US 2018/0022239 A1
(43) Pub. Date: Jan. 25, 2018

(54) VEHICLE SEAT DEVICE

(71) Applicant: AISIN SEIKI KABUSHIKI KAISHA, Kariya-shi (JP)

(72) Inventors: Takashi HATTORI, Kariya-shi (JP); Tomio MATSUFUJI, Kariya-shi (JP)

(73) Assignee: AISIN SEIKI KABUSHIKI KAISHA, Kariya-shi (JP)

(21) Appl. No.: 15/541,836

(22) PCT Filed: Mar. 22, 2016
(86) PCT No.: PCT/JP2016/058953

§ 371 Date: Jul. 6, 2017

(30) Foreign Application Priority Data
Mar. 30, 2015 (JP) 2015-069887

(51) Int. Cl. B60N 2/12; B60N 2/20; B60N 2/14

(52) U.S. Cl. CPC B60N 2/12; B60N 2/14; B60N 2/20

(57) ABSTRACT

A seat apparatus includes a seat slide mechanism switchable between an adjustment restricted state and an adjustment permitted state, a seat recliner mechanism, and a walk-in mechanism. The walk-in mechanism includes a first transmission member, a second transmission member and a clutch disposed between the first transmission member and the second transmission member. The second transmission member is displaced between a position where the seat slide mechanism is switched to the adjustment restricted state and a position where the seat slide mechanism is pressed to be switched to the adjustment permitted state in a state where displacement of the first transmission member is transmitted to the second transmission member. The clutch switches presence and absence of displacement transmission from the first transmission member to the second transmission member based on a contact pressure between the second transmission member and the seat slide mechanism.

### TECHNICAL FIELD

This invention relates to a seat apparatus for a vehicle.

### BACKGROUND ART

A seat apparatus for a vehicle generally includes a seat slide mechanism which is switchable between a locked state where a position adjustment of a vehicle seat is restricted and an unlocked state where the aforementioned position adjustment is permitted and a seat recliner mechanism which is switchable between a locked state where an angle adjustment of a seatback is restricted and an unlocked state where the aforementioned angle adjustment is permitted.

In addition, a seat apparatus including a walk-in mechanism which operates in conjunction with the seat slide mechanism and the seat recliner mechanism is disclosed in patent document 1.

The walk-in mechanism includes a wire and a rotary member. One end portion of the wire is connected to the seat recliner mechanism and the other end portion of the wire is connected to the rotary member. The rotary member is displaceable between a first rotary position and a second rotary position. The rotary member is separated from a lock member of the seat slide mechanism when positioned in the first rotary position. The rotary member presses the lock member to a position at which the seat slide mechanism is switched from the locked state to the unlocked state when the rotary member is displaced to the second rotary position.

In a case where the seatback is folded down to come close to a seating portion of the seat, the rotary member is displaced from the first rotary position to the second rotary position via the wire. Then, the rotary member presses the lock member with the rotation of the rotary member to thereby permit the adjustment of the vehicle seat in a front-rear position.

### DOCUMENT OF PRIOR ART

### Patent Document

Patent document 1: JP2003-182415A

### OVERVIEW OF INVENTION

### Problem to be Solved by Invention

In a case where the wire is too short, the rotary member rotates beyond necessity. In this case, because a contact pressure between the rotary member and the lock member increases, the rotary member and the lock member may not be separated from each other. On the other hand, in a case where the wire is too long, another rotary member for a sliding function may not rotate even though the aforementioned rotary member for the recliner function rotates. In this case, the walk-in function is inhibited from being exercised. Further, because the wire tends to extend with aging degradation, adjustment of the walk-in mechanism is difficult.

An object of the present invention is to provide a seat apparatus for a vehicle including a walk-in mechanism which may be easily adjustable.

### Means for Solving Problem

A seat for a vehicle which solves the aforementioned drawbacks includes a seat slide mechanism adjusting a position of a vehicle seat, the seat slide mechanism being switchable between an adjustment restricted state in which a position adjustment is restricted and an adjustment permitted state in which the position adjustment is permitted, a seat recliner mechanism adjusting an angle of a seatback, the seat recliner mechanism being switchable between an adjustment restricted state in which an angle adjustment is restricted and an adjustment permitted state in which the angle adjustment is permitted, and a walk-in mechanism disposed between the seat slide mechanism and the seat recliner mechanism to cause the seat slide mechanism and the seat recliner mechanism to operate in conjunction with each other, the walk-in mechanism including a second transmission member which is displaced between a position where the seat slide mechanism is switched to the adjustment restricted state and a position where the seat slide mechanism is pressed to be switched to the adjustment permitted state in a state where displacement of the first transmission member is transmitted to the second transmission member, and a clutch disposed between the first transmission member and the second transmission member, the clutch switching presence and absence of displacement transmission from the first transmission member to the second transmission member based on a contact pressure between the second transmission member and the seat slide mechanism.

### BRIEF DESCRIPTION OF DRAWINGS

FIG. 1 is a side view of a frame portion of a seat apparatus for a vehicle according to an embodiment;

FIG. 2 is an exploded perspective view of a clutch mechanism in the seat apparatus illustrated in FIG. 1;

FIG. 3A is a side view of the clutch mechanism;

FIG. 3B is a top view of the clutch mechanism;

FIG. 3C is a front view of the clutch mechanism;

FIG. 4A is an end view of a main portion of the clutch mechanism in a state where a rotation is transmitted;

FIG. 4B is an end view of the main portion of the clutch mechanism in a state where the rotation is not transmitted;

FIG. 5A is a side view of a main portion of a seat slide mechanism which is in a slide lock state;

FIG. 5B is a side view of the main portion of the seat slide mechanism which is in an intermediate state;

FIG. 5C is a side view of the main portion of the seat slide mechanism which is in a slide unlock state; and

FIG. 5D is a side view of the main portion of the seat slide mechanism which is in an excessively pressed state.

### MODE FOR CARRYING OUT THE INVENTION

A seat apparatus for a vehicle 1 according to an embodiment is explained with reference to the attached drawings.

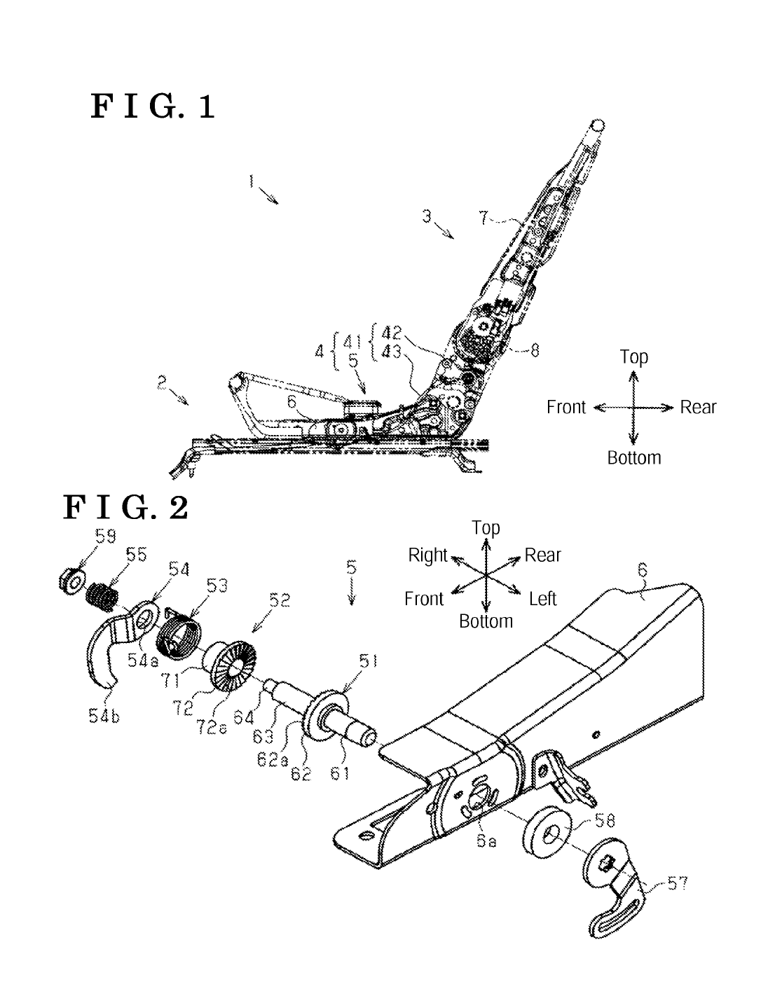

As illustrated in FIG. 1, the seat apparatus for the vehicle 1 (vehicle seat) includes a seat slide mechanism 2 which adjusts a front-rear position of the vehicle seat constituted by a seat cushion and a seatback and a seat recliner mechanism 3 which adjusts an angle of the seatback relative to the seat cushion. The seat apparatus for the vehicle 1 also includes a walk-in mechanism 4 connecting the seat slide mechanism 2 and the seat recliner mechanism 3 each other so that the seat slide mechanism 2 and the seat recliner mechanism 3 operate in conjunction with each other.

First, the seat slide mechanism 2 and the seat recliner mechanism 3 are explained. The aforementioned two mechanisms are technically known and thus explained in a simple manner.

### <Seat Slide Mechanism>

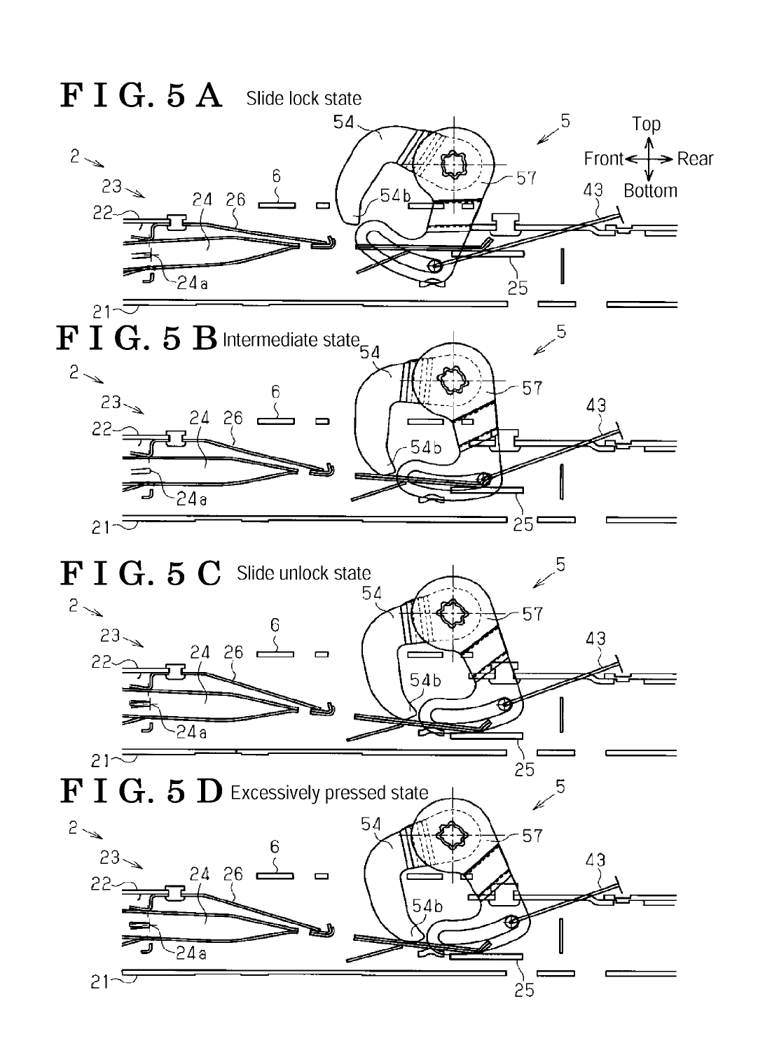

As illustrated in FIGS. 5A to 5D, the seat slide mechanism 2 includes a lower rail 21 which is fixed to a vehicle floor portion and which extends in a front-rear direction, an upper rail 22 which is displaceable relative to the lower rail 21 and a slide lock portion 23 mounted to the upper rail 22.

The slide lock portion 23 includes an operation lever 24 inserted to be positioned between the lower rail 21 and the upper rail 22. The operation lever 24 is supported to be pivotable at a pivot center portion 24a which is positioned at a center potion of the operation lever 24 in a longitudinal direction thereof.

The slide lock portion 23 includes an engagement portion 25 which is fixed to a rear end portion of the operation lever 24 and which selectively engages with an engagement protrusion, not illustrated, arranged next to the engagement portion 25 in a longitudinal direction of the lower rail 21.

The engagement portion 25 is displaced between a locked position (see FIG. 5A) and an unlocked position (see FIG. 5C). In a case where the rear end portion of the operation lever 24 moves upward, the engagement portion 25 is arranged at the locked position so as to engage with the engagement protrusion not illustrated. In a case where the rear end portion of the operation lever 24 moves downward, the engagement portion 25 is arranged at the unlocked position so as not to engage with the engagement protrusion not illustrated.

The slide lock portion 23 includes a lever spring 26 which biases the operation lever 24 upward at a rear side than the pivot center portion 24a. Because of a biasing force of the lever spring 26, the engagement portion 25 is constantly held at the locked position.

When the engagement portion 25 is positioned at the locked position, the slide lock portion 23 is in a slide lock state where displacement of the upper rail 22 relative to the lower rail 21 is restricted. When the engagement portion 25 is positioned at the unlocked position, the slide lock portion 23 is in a slide unlock state where displacement of the upper rail 22 relative to the lower rail 21 is permitted. That is, the seat slide mechanism 2 is switchable between an adjustment restricted state where adjustment of a position of the vehicle seat is restricted and an adjustment permitted state where adjustment of the position the vehicle seat is permitted.

The engagement portion 25 makes contact with the lower rail 21 from an upper side thereof when being positioned at the unlocked position, which is not illustrated. Because of such contact, the operation lever 24 is restrained from pivoting and causing the engagement portion 25 to move downward than the unlocked position.

<Seat Recliner Mechanism>

As illustrated in FIG. 1, the seat recliner mechanism 3 includes a rotation bracket 8 between a rear end portion of a seat cushion frame 6 and a lower end portion of a seatback frame 7 (seatback) serving as a frame of the seatback so that the rotation bracket 8 supports the seat cushion frame 6 and the seatback frame 7 to be rotatable. The seat recliner mechanism 3 also includes a lever, not illustrated, which is manually operated for selectively switching the seat recliner mechanism 3 between a rotation permitted state where a rotation of the seatback frame 7 relative to the seat cushion frame 6 is permitted and a rotation restricted state where the rotation is restricted and a spring, not illustrated, which biases the seatback frame 7 so that the seatback frame 7 comes closer to the seat cushion frame 6, i.e., so that the seatback is folded forward.

In a case where the lever not illustrated is operated, the seat recliner mechanism 3 is switched from the rotation restricted state where the rotation of the seatback frame 7 relative to the seat cushion frame 6 is restricted to the rotation permitted state. In a case where the rotation of the seatback frame 7 relative to the seat cushion frame 6 is permitted, the seatback frame 7 is folded forward by the biasing force of the spring not illustrated. That is, the seat recliner mechanism 3 is switchable between an adjustment restricted state where adjustment of an angle of the seatback is restricted and an adjustment permitted state where adjustment of the angle of the seatback is permitted.

<Walk-In Mechanism>

Next, the walk-in mechanism 4 is explained. Hereinafter, a rotation direction of each member is explained in a state where the seat apparatus 1 is viewed from a left side.

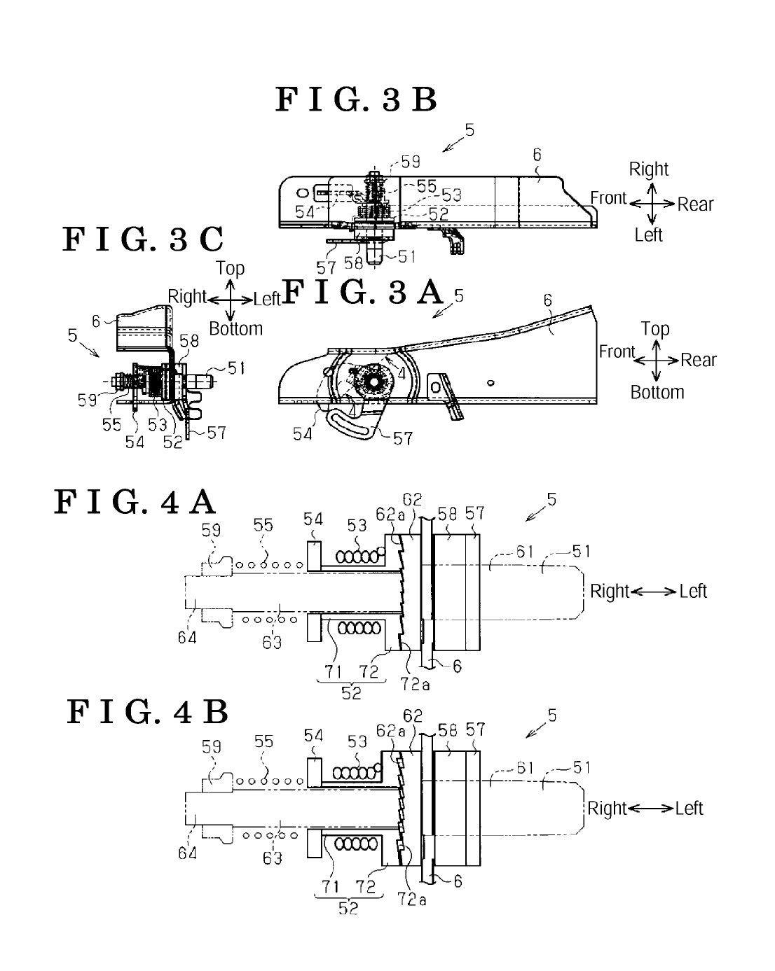

As illustrated in FIG. 1 and FIGS. 3A to 3C, the walk-in mechanism 4 includes a rotation transmission mechanism 41 mounted to the seatback frame 7 and a clutch mechanism 5 mounted to the seat cushion frame 6.

The rotation transmission mechanism 41 includes a winding portion 42 and a wire cable 43. One end portion of the wire cable 43 is fixed to the winding portion 42 and the other end portion of the wire cable 43 is fixed to a rotation lever 57 which is explained later.

The winding portion 42 is a member which rotates in conjunction with the rotation bracket 8. The winding portion 42 rotates in a counterclockwise direction in a case where the seatback frame 7 is folded forward beyond a specified angle. Accordingly, the wire cable 43 is pulled rearward. In a case where the seatback frame 7 is folded rearward, the winding portion 42 rotates in a clockwise direction to thereby permit the wire cable 43 to return forward. The rotation transmission mechanism 41 corresponds to a first transmission member which is displaced in conjunction with an angle change of the seatback.

As illustrated in FIG. 2, the clutch mechanism 5 includes a first clutch member 51, a second clutch member 52, a spiral spring 53, a pressing lever 54 and a coil spring 55. The first clutch member 51 includes a first shaft portion 61, a first clutch plate 62, a second shaft portion 63 and a third shaft portion 64.

The first shaft portion 61 is a column which extends in a left-right direction. The first shaft portion 61 includes an outer diameter which is slightly smaller than an inner diameter of a bore portion 6a which penetrates the seat cushion frame 6 in the left-right direction. The first shaft portion 61 is rotatably inserted to be positioned within the bore portion 6a. The rotation lever 57 is fixed to a left end portion of the first shaft portion 61. A washer 58 is disposed between the rotation lever 57 and the seat cushion frame 6.

The first clutch plate 62 is a circular disc including the same axis as the first shaft portion 61 and is continued to a right end portion of the first shaft portion 61. As illustrated in FIGS. 4A and 4B, a right surface of the first clutch plate 62 constitutes a first clutch surface 62a including plural inclined surfaces which are successively arranged in a circumferential direction in a stepped manner. The plural inclined surfaces are inclined relative to a surface orthogonal to a rotation axis of the first clutch plate 62 so that a rearward side of each of the inclined surfaces in the counterclockwise direction is positioned high. The plural inclined surfaces are arranged at equal angle intervals over an entire circumferential direction.

The second shaft portion 63 is a column including the same axis as the first shaft portion 61 and is continued to the right surface of the first clutch plate 62, i.e., to the first clutch surface 62a. The third shaft portion 64 which is simply illustrated in FIG. 2 is a screw shaft including the same axis as the first shaft portion 61 and is continued to a right end portion of the second shaft portion 63.

The second clutch member 52 includes a cylinder portion 71 and a second clutch plate 72. The cylinder portion 71 includes an inner diameter which is slightly greater than an outer diameter of the second shaft portion 63 and is smaller than an outer diameter of the first clutch plate 62.

The second clutch plate 72 is a flange continued to a left end portion of the cylinder portion 71. A left surface of the second clutch plate 72, i.e., a surface opposing the first clutch surface 62a constitutes a second clutch surface 72a including plural inclined surfaces which are successively arranged in the circumferential direction in a stepped manner. The plural inclined surfaces are inclined relative to a surface orthogonal to a rotation axis of the second clutch plate 72 so that a forward side of each of the inclined surfaces in the counterclockwise direction is positioned high. The plural inclined surfaces are arranged at equal angle intervals over the entire circumferential direction. An inclination angle of each of the inclined surfaces and the number of inclined surfaces constituting the second clutch surface 72a are the same as an inclination angle of each of the inclined surfaces and the number of inclined surfaces constituting the first clutch surface 62a.

The second clutch member 52 is mounted to the first clutch member 51 in a state where the second shaft portion 63 is inserted to be positioned within the cylinder portion 71 and the second clutch plate 72. The spiral spring 53 includes an inner diameter which is greater than an outer diameter of the cylinder portion 71 and is smaller than an outer diameter of the second clutch plate 72. One end of the spiral spring 53 is fixed to the seat cushion frame 6 and the other end of the spiral spring 53 is fixed to the pressing lever 54. The spiral spring 53 biases the pressing lever 54 so that the pressing lever 54 rotates in the clockwise direction. The spiral spring 53 is externally inserted to the cylinder portion 71.

The pressing lever 54 is a plate member in an L-shape. The pressing lever 54 includes an attachment bore Ma at an upper end portion so that the attachment bore 54a penetrates through in the left-right direction. The attachment bore 54a is specified to be equal to the inner diameter of the cylinder portion 71. A lower end portion of the pressing lever 54 serves as a pressing end portion 54b.

The pressing lever 54 is fixed to a right end portion of the cylinder portion 71 in a state where the second shaft portion 63 is inserted to be positioned within the attachment bore 54a. That is, the pressing lever 54 integrally rotates with the second clutch member 52. As illustrated in FIGS. 5A to 5D, the pressing lever 54 is positioned at an upper side of the operation lever 24. The pressing lever 54 is displaced between a non-pressing position at which the pressing lever 54 is away from the operation lever 24 and a pressing position at which the pressing lever 54 presses the operation lever 24, by the rotation of the second clutch member 52. The pressing lever 54 corresponds to a second transmission member.

The coil spring 55 includes an inner diameter which is slightly greater than the third shaft portion 64. The coil spring 55 is elastically compressed between a nut 59 which is screwed on the third shaft portion 64 and the pressing lever 54. An elastic force of the coil spring 55 is applied to the second clutch member 52 via the pressing lever 54. That is, the second clutch member 52 is pressed against the first clutch member 51. Because of the aforementioned pressing, the first clutch surface 62a (a contact surface of the first clutch member 51) and the second clutch surface 72a (a contact surface of the second clutch member 52) make surface contact with each other. The first clutch member 51 corresponds to a first rotary member and the second clutch member 52 corresponds to a second rotary member. The coil spring 55 corresponds to a biasing member.

<Operation of Walk-In Mechanism>

Next, an operation of the walk-in mechanism 4 is explained. At this time, as illustrated in FIG. 5A, the seat slide mechanism 2 is in the slide lock state and the seat recliner mechanism 3 is in a state before the seatback is folded forward.

In a case where the seatback is folded forward by the seat recliner mechanism 3, the rotation of the rotation bracket 8 in the counterclockwise direction is transmitted to the first clutch member 51 via the rotation transmission mechanism 41 and the rotation lever 57. As a result, the first clutch member 51 rotates in the counterclockwise direction.

As illustrated in FIG. 4A, the surface contact between the first clutch surface 62a and the second clutch surface 72a is maintained, so that the rotation of the first clutch member 51 in the counterclockwise direction is transmitted to the second clutch member 52. As a result, the second clutch member 52 rotates in the counterclockwise direction.

As illustrated in FIGS. 5B and 5C, the pressing lever 54 which integrally rotates with the second clutch member 52 also rotates in the counterclockwise direction. The pressing lever 54 rotates to the pressing position pressing the operation lever 24 from the non-pressing position. Accordingly, the rear end portion of the operation lever 24 is pressed down, so that the seat slide mechanism 2 is shifted from the slide lock state to the slide unlock state. The front-rear position of the seat is adjustable accordingly.

As illustrated in FIG. 5C, the engagement portion 25 of the operation lever 24 makes contact with the lower rail 21 from the upper side when being positioned at the unlocked position. Because of the aforementioned contact, the operation lever 24 is restrained from rotating so that the engagement portion 25 is displaced downward beyond the unlocked position. Therefore, the further rotation of each of the pressing lever 54 and the second clutch member 52 in the counterclockwise direction is restrained.

A case where the wire cable 43 is further pulled towards the seatback frame 7 so that the first clutch member 51 rotates in the counterclockwise direction is explained. As illustrated in FIG. 4A, the inclined surfaces constituting the first clutch surface 62a are inclined so that the rearward side of each of the inclined surfaces in the counterclockwise direction is positioned high. In addition, the inclined surfaces constituting the second clutch surface 72a are inclined so that the forward side of each of the inclined surfaces in the counterclockwise direction is positioned high. Therefore, in a case where the first clutch member 51 rotates in the counterclockwise direction in a state where the rotation of the second clutch member 52 in the counterclockwise direction is restricted, a force is generated at the second clutch member 52 to a right side by the inclined surfaces in contact with one another. Because of the aforementioned force to the right side, the coil spring 55 is elastically compressed to cause the second clutch member 52 to be displaced to the right side. Accordingly, the surface contact between the first clutch surface 62a and the second clutch surface 72a is eliminated or released, thereby rotating only the first clutch member 51 in the counterclockwise direction. As a result, rotation displacement of each of the pressing lever 54 and the second clutch member 52 which may cause an excessively pressed state where the pressing end portion 54b excessively contacts the operation lever 24 as illustrated in FIG. 5D is restrained.

Because the elastic force of the coil spring 55 is applied to the second clutch member 52, elimination of the surface contact is instantaneous. Thus, in a case where only the first clutch member 51 rotates in the counterclockwise direction in a state where the rotation of the second clutch member 52 in the counterclockwise direction is restricted, the rotation position of the second clutch member 52 is maintained.

Next, a case where the seatback frame 7 is folded rearward so that the rotation transmission mechanism 41 is brought to a state permitting the wire cable 43 to return towards the seat cushion frame 6 is explained.

In this case, a force for rotating the first clutch member 51 in the counterclockwise direction is eliminated or released. The second clutch member 52 is applied with the biasing force of the spiral spring 53 in the clockwise direction via the pressing lever 54. Thus, the first clutch member 51, the second clutch member 52 and the pressing lever 54 integrally rotate in the clockwise direction. The seat slide mechanism 2 returns from the slide unlock state to the slide lock state accordingly.

As mentioned above, according to the present embodiment, the following effects are obtainable.

(1) The clutch mechanism 5 is provided at the walk-in mechanism 4. The clutch mechanism 5 eliminates the surface contact between the first clutch surface 62a and the second clutch surface 72a to interrupt rotation transmission from the first clutch member 51 to the second clutch member 52 in a state where the seat slide mechanism 2 is in the slide unlock state, i.e., in a state where the rear end portion of the operation lever 24 is restricted from rotating in the lower direction. That is, in a case where a contact pressure between the pressing lever 54 and the operation lever 24 reaches a setting value, transmission of displacement from the rotation transmission mechanism 41 to the pressing lever 54 is interrupted by the clutch mechanism 5. The contact pressure between the pressing lever 54 and the operation lever 24 is constantly equal to or below the setting value. Accordingly, the second clutch member 52 is inhibited from rotating in the counterclockwise direction so that the pressing lever 54 is inhibited from pressing the operation lever 24. The operation lever 24 is restrained from becoming the excessively pressed state. Circumstances where the operation lever 24 and the lower rail 21 are stuck each other and the pressing lever 54 and the operation lever 24 are stuck each other, for example, are inhibited from occurring. That is, circumstances where the pressing lever 54 is not displaced from a position (pressing position) at which the seat slide mechanism 2 is switched to the adjustment permitted state to a position (non-pressing position) at which the seat slide mechanism 2 is switched to the adjustment restricted state do not occur.

The clutch mechanism 5 interrupts the rotation transmission to the second clutch member 52 as long as the seat slide mechanism 2 is brought to the slide unlock state, regardless of the state of the rotation transmission mechanism 41, for example, a state where the wire cable 43 is loose or the length of the wire cable 43 is too short, for example. Therefore, the rotation transmission mechanism 41 simply transmits the rotation of the seatback so that the seat slide mechanism 2 may be at least shifted from the slide lock state to the slide unlock state. The adjustment of the rotation transmission mechanism 41 and further the adjustment of the walk-in mechanism 4 are easily conducted. That is, a relationship between the rotation transmission mechanism 41 and the pressing lever 54 is simply adjusted so that the pressing lever 54 is displaced from the position at which the rotation transmission mechanism 41 switches the seat slide mechanism 2 to the adjustment restricted state to the position at which the rotation transmission mechanism 41 switches the seat slide mechanism 2 to the adjustment permitted state. The adjustment of the walk-in mechanism 4 is easily conducted accordingly.

(2) The inclined surfaces constituting the first clutch surface 62a and the inclined surfaces constituting the second clutch surface 72a are inclined in the same directions as each other relative to the surface orthogonal to the rotation axes of the clutch plates 62 and 72. The function as the clutch may be exercised with the simple construction as the inclined surfaces accordingly.

(3) The inclined surfaces constituting the first clutch surface 62a and the inclined surfaces constituting the second clutch surface 72a are arranged at equal angle intervals over the entire circumferential directions of the respective clutch surfaces. Thus, the first clutch surface 62a and the second clutch surface 72a may be easily meshed with each other regardless of the rotation state of each of the first clutch member 51 and the second clutch member 52.

The aforementioned embodiment may be changed as follows.

In the aforementioned embodiment, the inclined surfaces are arranged at equal angle intervals over the entire circumferential direction of each of the first clutch surface 62a and the second clutch surface 72a. At this time, the inclined surfaces are not necessarily arranged over the entire circumferential direction or not necessarily arranged at equal angle intervals. Even a construction where at least one inclined surface is provided at a specific portion in the circumferential direction of each of the clutch surfaces 62a and 72a may exercise the effect of item (1) of the aforementioned embodiment.

1. A seat apparatus comprising:
a seat slide mechanism adjusting a position of a vehicle seat, the seat slide mechanism being switchable between an adjustment restricted state in which a position adjustment is restricted and an adjustment permitted state in which the position adjustment is permitted;
a seat recliner mechanism adjusting an angle of a seatback, the seat recliner mechanism being switchable between an adjustment restricted state in which an angle adjustment is restricted and an adjustment permitted state in which the angle adjustment is permitted; and
a walk-in mechanism disposed between the seat slide mechanism and the seat recliner mechanism to cause the seat slide mechanism and the seat recliner mechanism to operate in conjunction with each other,
the walk-in mechanism including:
a first transmission member which is displaced in conjunction with an angle change of the seatback;
a second transmission member which is displaced between a position where the seat slide mechanism is switched to the adjustment restricted state and a position where the seat slide mechanism is pressed to be switched to the adjustment permitted state in a state where displacement of the first transmission member is transmitted to the second transmission member; and
a clutch disposed between the first transmission member and the second transmission member, the clutch switching presence and absence of displacement transmission from the first transmission member to the second transmission member based on a contact pressure between the second transmission member and the seat slide mechanism.

2. The seat apparatus according to claim 1, wherein the clutch includes:
a first rotary member rotating in conjunction with the first transmission member;
a second rotary member including a common rotation axis to the first rotary member, the second rotary member being displaced between a rotation transmitted position where the second rotary member makes surface contact with the first rotary member in a direction where the rotation axis extends and a rotation non-transmitted position where the surface contact is released; and
a biasing member biasing the second rotary member towards the first rotary member,
the first rotary member and the second rotary member including contact surfaces respectively, the contact surfaces making surface contact with each other, the contact surfaces including inclined surfaces inclined relative to a surface orthogonal to the rotation axis, each of the inclined surfaces applying a force in a direction opposite from a biasing force of the biasing member in a case where the first rotary member rotates the second rotary member so that the second transmission member presses the seat slide mechanism.

3. The seat apparatus according to claim 2, wherein a plurality of the inclined surfaces is provided at each of the contact surfaces of the first rotary member and the second rotary member at equal angle intervals over an entire circumferential direction.

4. The seat apparatus according to claim 3, wherein the plurality of the inclined surfaces provided at each of the contact surfaces of the first rotary member and the second rotary member is arranged successively in a circumferential direction in a stepped manner.
